(19) United States
(12) Patent Application Publication
(10) Pub. No.: US 2026/0081196 A1
(43) Pub. Date: Mar. 19, 2026

(54) PLANT-BASED ELECTRICAL DEVICES

(71) Applicant: ARIZONA BOARD OF REGENTS ON BEHALF OF THE UNIVERSITY OF ARIZONA, Tucson, AZ (US)

(72) Inventor: Frederic ZENHAUSERN, Phoenix, AZ (US)

(21) Appl. No.: 19/108,633

(22) PCT Filed: Sep. 8, 2023
(86) PCT No.: PCT/US2023/032265

§ 371 Date: Mar. 4, 2025

Related U.S. Application Data
(60) Provisional application No. 63/404,813, filed on Sep. 8, 2022.

(51) Int. Cl. H01M 8/16; H01M 10/36; H01M 50/429

(52) U.S. Cl. CPC H01M 8/16; H01M 10/36; H01M 50/4295

(57) ABSTRACT

A device may include a decellularized biological scaffold, a first electrode, and a second electrode, wherein the decellularized biological scaffold is in electrical and/or chemical communication with the first and second electrodes. In one example, the device is a battery and the device may include an electrolyte layer supported on the decellularized biological scaffold; an anode layer disposed on a first side of the electrolyte layer; and a cathode layer disposed on second side of the electrolyte layer, opposite the anode layer. The electrolyte layer may include a plant-based conductive hydrogel and/or a PEDOT collagen matrix. The anode and/or the cathode layer may comprise metallic vesicles secreted by a plant.

### CROSS-REFERENCE TO RELATED APPLICATIONS

This application claims the benefit of priority of U.S. Provisional Patent App. No. 63/404,813, filed Sep. 8, 2022, which is hereby incorporated by reference in its entirety.

### BACKGROUND OF INVENTION

Climate change, global healthcare access challenges and future Human Exploration into deep space will result in long human isolation which will impact the production and access to critical energy sources. Autonomous bio-regenerative energy life support will have to be developed preferably from bioavailable matter.

Paper electronics offer an environmentally sustainable option for flexible and wearable systems which also fits the available printing technologies for high manufacturing efficiency. Paper-based batteries with high volumetric energy density have been demonstrated. However, their printing processing doesn't satisfy the requirements for a true green eco-friendly fabrication. They still require noble materials mining, paper milling and solvent-based screen printing. Although these batteries are flexible, they are not biocompatible for being directly implanted into a human body for biomedical use. More recently, it has been reported in the prior art that the cuticle-cellular tissue bilayer in higher plant leaves could function as an integrated triboelectric generator conductor coupler capable of converting mechanical stimuli into electricity. This also revealed that charges can be induced and transported in living plant tissue whereas charges remain unbalanced and trapped on dead leaves. However, these systems cannot be rechargeable which may limit their use to direct drive of an electronic device.

Thus, it can be seen from the foregoing that improved electronic devices are needed.

### SUMMARY OF THE INVENTION

Provided herein are methods and systems that provide an innovative approach to a plant-based rechargeable battery with all components produced naturally making its operations sustainable and suitable for flexible, wearable, or implantable applications.

The disclosed plant-based materials and processes may provide a broad energy source platform that can produce the necessary mechanical, biochemical, chemical and electrical power to support sustainable and self-contained energy systems to aliment biological entities (e.g. a human individual in a remote Earth ecosystem, or an astronaut on Mars), but also to power electronic ancillaries (e.g. computer, wearable sensors) or implantable devices for life support (e.g. wound healing, cardiac stimulator such as pacemaker).

In one embodiment, metals to be used in the plant-based devices can be extracted from the environment, preferably soils or water, by hyperaccumulator plants through phyto-assisted conversion and reactions. Plant scaffolds are mostly composed of cellulose which can be prepared, for example, by green decellularization processing using supercritical fluid CO2 without using any chemical solvent. Such a process is disclosed in US Application Publication No. 2022/0236255 to Lacombe, et al, the contents of which are hereby incorporated by reference for all purposes. In other embodiments, solvent-based decellularization may be employed.

Cellulose fibers and pores of the scaffold can also be impregnated by natural hydrogel polymers (e.g. Aloe Vera) while metal nanoparticles can be produced by the plant hyperaccumulator extracellular vesicles, or exosomes. Liquid metals or conductive bio-polymers can also be loaded into the vasculature network of the leaf scaffold to facilitate integrating electrodes. In one embodiment, an electrical device (e.g., a battery) may be produced using a decellularized leaf scaffold filled with plant conductive hydrogels (or PEDOT collagen matrices) and coated with Cd plant exosomes on one side, the other side being coated with Ni plant exosomes creating an assembly of a Ni—Cd battery, for example. The other layers of a battery, i.e. the electrolyte and current collectors can also be derived from the plant vesicles and substrate accordingly (e.g. PEV-FE-like current collector layer). In other embodiments, circuitry can be built in the vasculature network of the leaf using metallic vesicles or other conductive polymer to create electrical devices such as RF antennae.

In a preferred embodiment, a novel rechargeable electrical power source is built in and around a leaf of a plant.

In one embodiment, a plant-derived electrical device may provide novel electrical-power source directly integrated with wound healing materials for locally stimulating biological reactions with therapeutic effects. These may also be combined with embedded electronic circuitry to actuate, monitor, or control wearable or implanted medical devices. As these materials can be biodegradable, they could also reduce interventions for the removal of defective or old devices from the human body. It is also foreseeable that culturing plant using hydroponic conditions (e.g. using various types such as the wick system, water culture, Ebb and flow, drip, nutrient film technology (NFT) or aeroponics), these systems could be prepared, assembled and used on demand which would make them suitable for supporting the needs for supporting life conditions (e.g. physiology, nutrition and energy sources) in remote isolation such as after a climate change disaster, or supporting health in space during deep space flight missions or confined planetary habitats (e.g. Mars flight or landing).

In one embodiment, a device may comprise a decellularized biological scaffold; a first electrode; and a second electrode, wherein the decellularized biological scaffold is in electrical and/or chemical communication with the first and second electrodes. In one embodiment, the biological scaffold comprises a biopolymer derived from a plant. In one embodiment, the biological scaffold is selected from the group consisting of a cellulose scaffold, a chitosan scaffold and a pectin scaffold. In one embodiment, the device is a battery.

In one embodiment, the device may include: an electrolyte layer supported by the decellularized biological scaffold; an anode layer disposed on a first side of the electrolyte layer; and a cathode layer disposed on second side of the electrolyte layer, opposite the anode layer. In one embodiment, the electrolyte layer is within the decellularized biological surface, supported by a surface of the decellularized biological surface, or both within and supported by a surface of the decellularized biological surface.

In one embodiment, the electrolyte layer comprises a plant-based conductive hydrogel and/or a PEDOT collagen matrix. In one embodiment, the anode and/or the cathode layer comprises metallic vesicles.

In one embodiment, the device may comprise: a first charge collection layer disposed on the cathode layer; and a second charge collection layer disposed on the anode layer. In one embodiment, the first and/or second charge collection layers comprise metallic vesicles.

In one embodiment, the decellularized biological scaffold includes vasculature, the device comprising metal disposed in the vasculature to create electronic circuitry in the vasculature. In one embodiment, the metal disposed in the vasculature comprises metallic vesicles. In one embodiment, the metal disposed in the vasculature comprises a conductive polymer.

In one embodiment, the device is an RF antenna. In one embodiment, the device is flexible. In one embodiment, the device is wearable. In one embodiment, the device is implantable. In one embodiment, the device is biodegradable.

In one embodiment, a method of manufacturing a plant-derived battery comprises: decellularizing a plant tissue to form a decellularized cellulose scaffold; contacting the decellularized cellulose scaffold with an electrolyte material to form an electrolyte layer supported by the decellularized cellulose scaffold; contacting the electrolyte material with an anode material to form an anode layer disposed on a first side of the electrolyte layer; contacting the electrolyte material with a cathode material to form a cathode layer disposed on a second side of the electrolyte layer, opposite the anode layer.

In one embodiment, the method comprises contacting the cathode and anode layers with a charge collection material to form a first charge collection layer disposed on the cathode layer and a second charge collection layer disposed on the anode layer.

In one embodiment, the electrolyte layer comprises a plant-based conductive hydrogel and/or a PEDOT collagen matrix. In one embodiment, the anode and/or the cathode layer comprises metallic vesicles derived from plant-exosomes or other secreted vesicles.

In one embodiment, the method comprises: removing one or more metals from a plant growth medium via a hyper-accumulating plant; forming metallic vesicles in the hyper-accumulating plant; extracting the metallic vesicles from the hyper-accumulating plant. In one embodiment, the plant growth medium is a soil.

In one embodiment, the decellularizing step comprises contacting the plant tissue with supercritical CO2.

In one embodiment, a method of extracting one or more metal materials from a plant growth medium comprises: growing a hyper-accumulating plant in the plant growth medium; extracting one or more metals from the growth medium into the hyper-accumulating plant; forming metallic vesicles in the hyper-accumulating plant; extracting the metallic vesicles from the hyper-accumulating plant; isolating the metallic vesicles, purifying and characterizing the metallic vesicles. In one embodiment, the metallic vesicles may be isolated via ultracentrifugation. In one embodiment, the metallic vesicles may be isolated via size exclusion chromatography. In some embodiments, the metallic vesicles may be analyzed via SEM, TEM or other microscopy techniques, and/or flow cytometry. In some embodiments the metallic vesicles may be analyzed via proteomics, lipidomics and/or other omics analysis techniques.

In one embodiment, field corn may be used as a feedstock for producing sustainable chemicals and components for the battery system via: (i) metal extraction for battery materials from corn plants, (ii) corn carbonization for battery device applications, and (iii) the utilization of decellularized corn leaf as a battery separator and cellulose source for cellulose acetate. Combination of these three components produces a flexible, rechargeable, corn-based battery.

### BRIEF DESCRIPTION OF THE DRAWINGS

FIG. 1A is a schematic depiction of a first embodiment of a method for manufacturing a plant-derived battery in accordance with one embodiment of the present disclosure.

FIG. 1B is a graph showing discharge performance of a plant-based battery.

FIG. 1C is a graph showing a cyclic voltammetry curve for a plant-based battery.

FIG. 1D is a schematic depiction of layers of flexible plant-based battery including a decellularized plant scaffold impregnated with an electrolyte gel and electrode layers.

FIG. 2 is a schematic depiction a second embodiment of a method for manufacturing a plant-derived battery.

FIG. 3 is a schematic depiction of a process for manufacturing a corn-based battery.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

As used herein, “decellularization” means the removal of cellular components from a tissue while preserving its extracellular matrix, including vasculature network.

As used herein, “a decellularized biological scaffold” means a biological tissue that has been decellularized to remove most or all of the biological components including nucleic acid (e.g. DNA, RNA) and/or protein or lipid—containing cellular components of the tissue, leaving the biological vasculature intact.

As used herein, “metallic vesicles” means extra cellular plant vesicles containing one or more metals encapsulated in an organic membrane, for example an exosome or a nanolipid particle or carrier. The metals may be extracted from the soil or water by hyperaccumulator plant species and collected in the vesicles, which are then extracted as described below. The metals of the metallic vesicles may comprise gold, iron, copper, silver, chromium, cadmium, lithium, cobalt, nickel and/or aluminum. The metallic vesicles may comprise a metal particle such as a metal microsphere, or a nanostar, or other hybrid composition of nanomaterials. In some aspects, the metallic vesicles may comprise nanostructures that may be loaded with metals during a vesicle formation processing step.

As used herein, “hyperaccumulator” is a plant or a fungi capable of growing in soil, water, or other growth media having high concentrations of metals. Hyperaccumulators absorb these metals preferably through their roots, and concentrate unusually high levels of metals in their tissues. One example of a hyperaccumulator is duckweed.

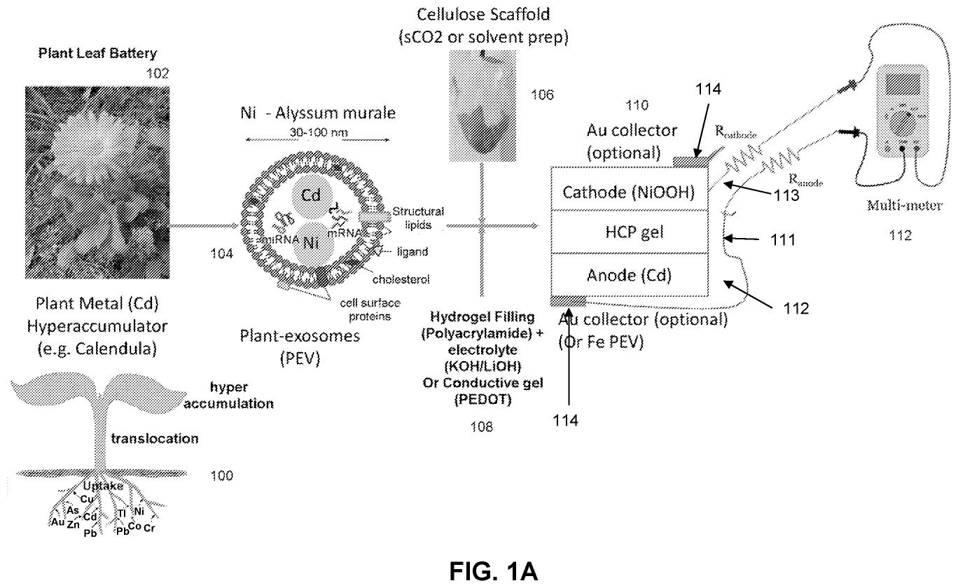

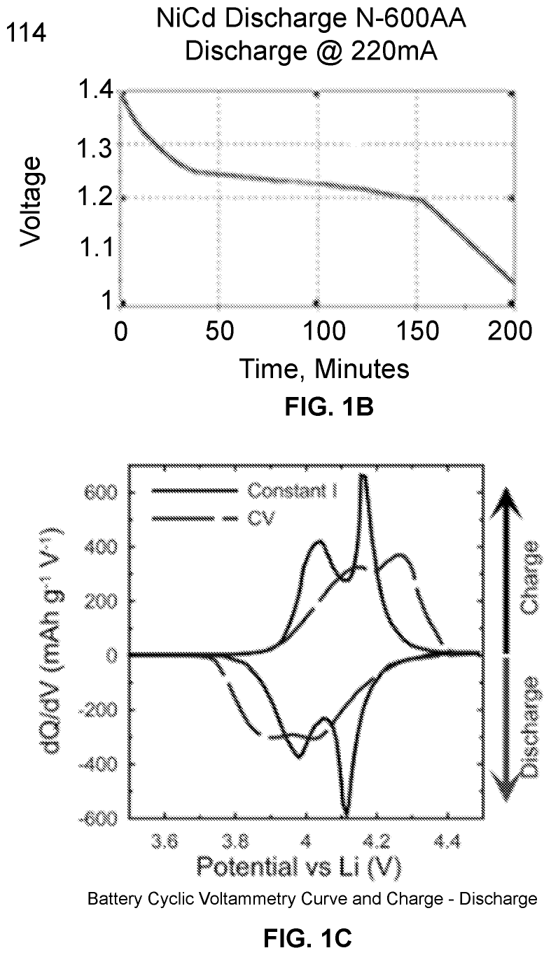

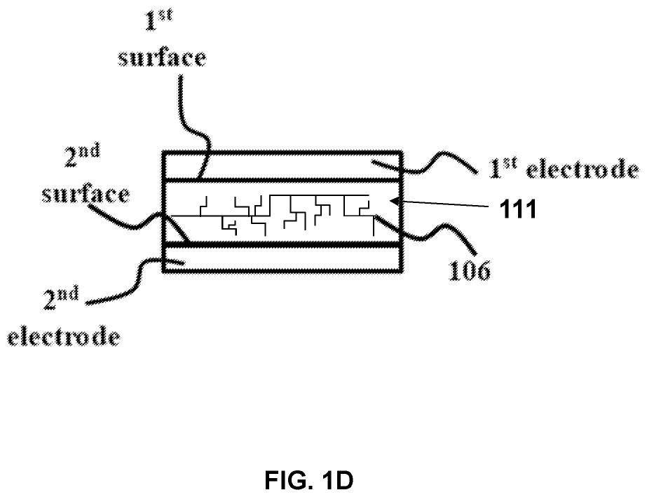

FIG. 1A illustrates the embodiment of the present invention starting with the environmental intake of metals (100) by a metal hyperaccumulator plant (102) species that can metabolize metals as often found in soils or water. In one embodiment, the metal hyperaccumulator plant may be Calendula. In one embodiment, the metal hyperaccumulator plant may be Wolffia. In one embodiment, the metal hyperaccumulator plant may be Alyssum murale. These plants can detoxify metals by phytoremediation or other metabolic pathways. These plants can also form plant-based exosome particles which can accumulate the metals (104).

The plant-based flexible battery (110) is composed of 3 major layers including: organic/inorganic hybrid electrolyte layer (111) supported on a decellularized plant cellulose scaffold 106, an anode (112) disposed on a first side of the electrolyte layer and a cathode (113) disposed on a second side of the electrolyte layer, opposite the anode layer. Current collectors (114) may complete the outermost layers of the battery package. In some embodiments, the layered structure of the plant-based battery (110) may be repeated multiple times to produce a stacked battery structure.

The illustrated embodiment accomplishes the assembly by preparing a first decellularized plant cellulose scaffold (106). The scaffold may exhibit various different mechanical properties depending on the type of plant selected. For example, spinach leaves are soft whereas bamboo tubes are stiff, thus the scaffold may exhibit a broad range of stiffness. Thus, in some embodiments, the scaffold may exhibit a Young's modulus from 1 to 10,000 kPa.

Elasticity may also be a criterion for consideration, with preferred Poisson's ratio in the range of 0.01 to 1 depending on the device application (e.g. skin-based implant). The vasculature network of the scaffold is preferably from a plant having leaf vasculature with internal width in the range from 1 to 100 um, allowing for metal vesicles or biopolymer loading to flow through the vasculature network. The first decellularized plant cellulose scaffold (106) may be prepared using chemical treatment or supercritical fluid CO2 processing (see, e.g., US Application Publication No. 2022/0236255 to Lacombe,). The scaffold (106) can then be filled (108) using a hydrogel. In one embodiment, the hydrogel may comprise polyacrylamide combined with KOH and/or LiOH as the electrolyte. In another embodiment, the scaffold may be filled with a conductive PEDOT gel.

In one aspect, intact leaves with their prominent branching vascular network feature (e.g. spinach, tomatoes, basil, celery and/or other edible plants or angiosperms) can be directly decellularized by sfCO2 treatment or by serial chemical treatment using hexanes, sodium dodecyl sulfate (SDS) and bleach solutions, for example. The scaffolds can then be rinsed in distilled H2O to remove any residual chemicals. An optimal level of hydration needed within the leaf scaffold, may be assessed using a commercially available moisture analyzer. Then, a needle is placed in the base of the leaf stem. The other end of the needle connects to a reservoir of reagents including hydrogel solution. At the optimal hydration level, fluid may advance through the vascular network of the scaffold by capillary action. Once the vascular network is filled, the needle with reservoir is removed. The leaf is imaged for analysis and the remaining fluid in the reservoir is measured to determine the average volume needed to fill the vascular network. Other techniques represented by mimicking a transpiration cycle like in a synthetic tree could be used for passive fluid motion. Automated imaging software tools have been designed specifically for segmenting and analyzing leaf vein structure such as phenoVein62, LeafGUI63 or LeafVeinCNN64. These software tools may be employed to determine the hydration level that allows the liquid to travel the longest path and to colonize the maximum number of nodes/veins in the scaffold.

In another aspect, hydrogel loading to form an electrolyte layer may be achieved via a casting process which may be less desirable due to the perturbation of the innate vasculature system. Surface contact angle may be optimized and preferably in the range of approximately 20-90 degrees for facilitating fluid flow. In one embodiment, the cellulose content extracted from a corn leaf can be further processed to obtain cellulose acetate. Cellulose acetate is a widely-used structure enhancer for gel polymer electrolytes in batteries. The cellulose acetate may serve to enhance the mechanical stability and ion conductivity of the gel polymer electrolyte, improving the overall performance and safety of batteries. These components can exhibit low electronic conductivity, porous structure, and excellent ion transfer properties of decellularized plant materials, including plant leaf, in battery applications.

The cathode and anode may be prepared by depositing PEV-Metal particle mixtures (e.g. NiOOH-like cathode; Cd anode) on opposed scaffold surfaces. In some aspects, a carbonization process may be used, for plant derived biomass (e.g., corn husks and/or cobs). The carbonization process may include controlled pyrolysis. This thermal treatment decomposes the organic matter in the biomass, leaving behind carbon-rich materials with desirable properties to produce high-quality carbon materials with excellent electrochemical performance for use in battery electrode applications such as Li-S, Li-ion and Na-ion batteries. The carbonized plant materials can be further processed into electrode structures, such as anodes or separators, or utilized as conductive additives in battery systems. These carbon materials exhibit excellent electrical conductivity, high specific surface area, and good structural stability, contributing to improved battery performance, energy efficiency, and cycle life. The incorporation of cellulose acetate improves the mechanical stability, cell safety, and overall performance of gel polymer electrolytes in batteries. This, in turn, enhances battery safety, lifespan, and energy efficiency. Other systems combining Zinc-ion engineered Plant-based multifunctional hydrogels and Zinc-ion hybrid capacitors can also be applied in the present invention. Such electrode configurations could also be applicable to fuel cell devices as described in International Publication Number WO2005050763A1, the content of which is hereby incorporated in its entirety.

Current collectors can be deposited on the outermost layers by using various materials and techniques, such as carbon nanotubes ink printing; Au nanoparticles or nanostars; or using PEV-Fe like materials. An electrical circuit can then be formed by connecting electronic measurement devices (112) and components (e.g. resistors) to the plant-battery assembly to investigate the characteristics of the energy source, power load and preferably when assessing charge-discharge performance (114).

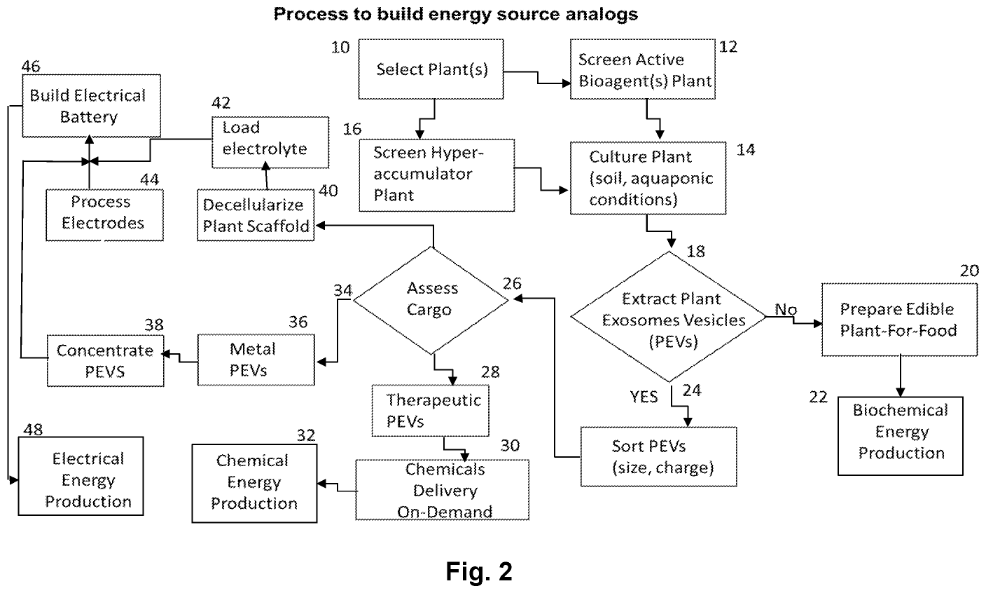

Turning now to FIG. 2 a method to build energy source analogs to support the production of biochemical, chemical and electrical energies is illustrated. In the illustrated embodiment, the method begins with the selection of plant materials (10), screening (12) for any bioactive agent(s) intrinsic to the plant (e.g. flavonoids and anti-oxidants or anti-inflammatory compounds or other active molecule that could act as radical or electron scavengers) while preparing for culturing the plant either in soil or aquaponic conditions (14) which may also be suitable when screening for hyperaccumulator plant (16) that can often metabolize metals.

Then plant extracellular vesicles (PEVs), including exosomes, can be extracted (18) by various processing techniques such as ultracentrifugation, ultra-filtration or size exchange chromatography or combination thereof, or by any other separation method known by those skilled in the art. If no PEVs are extracted, then the plant can be prepared as edible food component (20) which can serve as biochemical energy source (22) to feed a mammalian preferably in limited resources settings or at a remote location (e.g. soldier in a battlefield, astronaut in a space mission or habitat).

When PEVs are produced, they can be sorted for their various physico-chemical properties (24), such as size distribution or charges, using analytical techniques such as Diffracted Light Scattering (DLS), Nanoparticle Tracking Analysis (NTA), electron microscopy (e.g. SEM, TEM) and zeta potential measurement. Chemical content can be characterized by spectroscopy such as FT-IR, NMR or other relevant analytical instrumentation. By assessing the particles cargo content (26), they can contain some active bioagent or be loaded with drugs to provide therapeutic activities (28) that can play the role of on-demand drug or chemical delivery system (30) to generate chemical energies (32), typically when they are consumed by an individual experiencing health imbalance, an infection by a virus or a bacteria, or other host interactions necessitating some therapeutic effects through chemical interactions at the molecular or cellular level.

PEV cargo can also be assessed (34) by other spectroscopic techniques (e.g. Atomic Absorption Spectroscopy) to identify the content of inorganic materials such as metals (36) from hyperaccumulator plant species. PEV with metals can be concentrated (38) to increase the concentration of metal required to be used in a rechargeable battery. Some of the plant materials can also be decellularized (40) by chemical treatment but preferably by supercritical fluid CO2 acting as a green solvent, to prepare the cellulosic scaffold retaining the inner vasculature network architecture forming vessel-like structures and porous surfaces that can then be loaded with electrolyte materials (42) such as hydrogels or other biopolymers acting as a battery electrolyte layer which can then be connected with electrodes. These latter can also be formed (44) within the vasculature network or be deposited onto the surface of the plant materials using printing of conductive biopolymers, or conventional inorganic materials such as liquid metals.

The various components described above can then be prepared for assembly into a functional electrical source or battery (46) that can be a rechargeable and flexible Ni—Cd battery or other hybrid configuration for producing sufficient electrical energy (48) to power a sensor (e.g. RF antenna), an electronic appliance (e.g. smartphone, digital camera) or a wearable system (e.g. digital watch, ring, etc.) or any other system that may require electrical energy to operate.

### Example 1—Corn-Based Battery

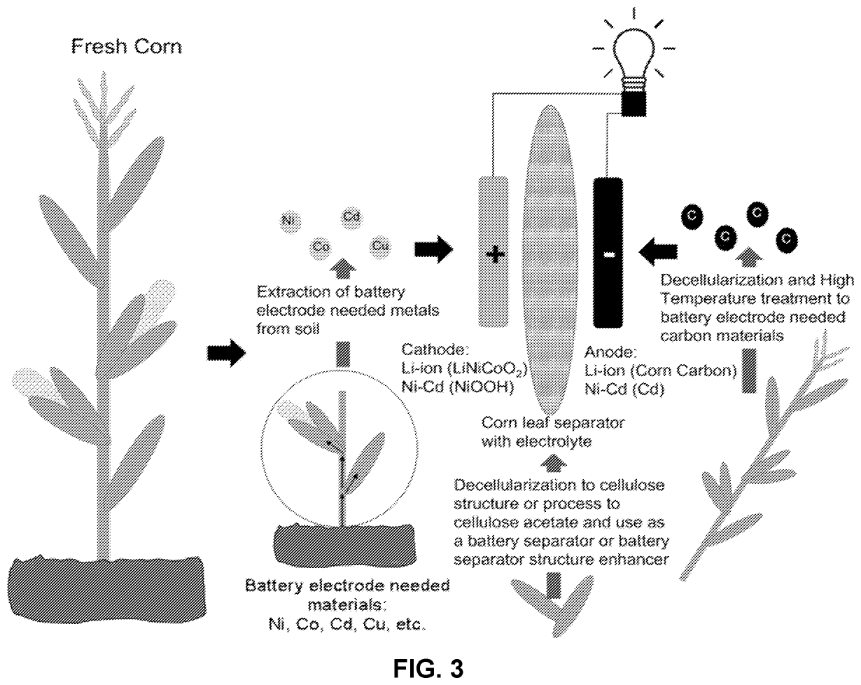

Turning now to FIG. 3, corn may be used to produce nano-vesicles with cargo that contains metals. The recovered metals may then be further processed and supplied as battery materials for various energy storage applications. Nickel (Ni) and cobalt (Co) are two key elements for lithium-ion batteries.

Corn may be employed as a battery feedstock as follows: (i) metal extraction from a growth medium (e.g., soil or hydroponic liquid) for battery materials via corn plants, (ii) corn carbonization for battery device applications, and (iii) the utilization of decellularized corn leaf as a battery separator and cellulose source for cellulose acetate. By integrating these three components, a flexible rechargeable battery may be produced from corn.

i. Metal Extraction for Battery Material

In one embodiment, metals may be extracted from a growth medium via corn. The metals may include nickel (Ni), cobalt (Co), copper (Cu), cadmium (Cd), and others.

The metal extraction process begins with the collection and pretreatment of corn biomass, such as cornstalks, corn cobs, or unsellable/polluted corn. The biomass undergoes a series of steps, including milling, size reduction, and drying, to prepare it for the extraction process. Subsequently, the corn biomass is subjected to a leaching process using environmentally friendly solvents and extractants. This process facilitates the dissolution and recovery of the target metals from the biomass.

After the leaching process, the metal-containing solution undergoes a series of separation and purification steps to isolate the desired metals. These steps may include solvent extraction, precipitation, filtration, and electrochemical deposition, depending on the specific metal and purity requirements. Note that edible corn can also mass produce nanoparticles with cargo that could contain metals. The recovered metals can then be further processed and supplied as battery materials for various energy storage applications.

ii. Corn Carbonization for Battery Applications

Corn biomass may be carbonized to produce carbon materials suitable for battery applications, including anodes, cathodes, and/or conductive additives. The carbonization process involves subjecting corn biomass, such as corn husks or cobs, to controlled pyrolysis under specific temperature and pressure conditions. This thermal treatment decomposes the organic matter in the biomass, leaving behind carbon-rich materials with desirable properties for battery electrode applications.

The carbonized corn materials can be further processed into electrode structures, such as anodes or separators, or utilized as conductive additives in battery systems. These carbon materials exhibit excellent electrical conductivity, high specific surface area, and good structural stability, contributing to improved battery performance, energy efficiency, and cycle life.

iii. Decellularized Corn Leaf as Battery Separator and Cellulose Source

Decellularized corn leaves may be used as a battery separator. Furthermore, the cellulose extracted from the corn leaves may be used for the production of cellulose acetate.

The production process involves the decellularization of corn leaves to remove cellular components, leaving behind a porous leaf structure suitable for ion transfer in battery separators. The decellularization process utilizes enzymatic or chemical treatments to dissolve cellular material while preserving the leaf's structural integrity. In one aspect, the corn leaves may be decellularized via supercritical CO₂. The resulting decellularized corn leaf serves as a natural, low electronic conductivity separator for battery applications.

Additionally, the cellulose content extracted from the corn leaves can be further processed to obtain cellulose acetate. Cellulose acetate may serve as a structural enhancer for gel polymer electrolytes in batteries. The cellulose acetate enhances the mechanical stability and ion conductivity of the gel polymer electrolyte, improving the overall performance and safety of batteries.

Decellularized plant materials as battery separators and cellulose acetate sources may achieve low electronic conductivity, porous structure, and excellent ion transfer properties of decellularized plant materials, including corn leaf, in battery applications.

### ASPECTS

Aspect 1. A plant-based battery comprising:
   a decellularized biological scaffold;
   an electrolyte layer supported by the decellularized biological scaffold;
   an anode layer disposed on a first side of the electrolyte layer; and
   a cathode layer disposed on second side of the electrolyte layer, opposite the anode layer, wherein the decellularized biological scaffold is in electrical and/or chemical communication with the first and second electrodes
   wherein the plant-based battery is configured to store and discharge electrical energy.
Aspect 2. The device of aspect 1, wherein the anode and/or the cathode layer comprises metallic vesicles.
Aspect 3. The device of aspect 1 or 2, wherein the first and/or second charge collection layers comprise metallic vesicles.
Aspect 4. The device of any of aspects 1-3, wherein the biological scaffold comprises a biopolymer derived from a plant.
Aspect 5. The device of any of aspects 1-4, wherein the biological scaffold is selected from the group consisting of a cellulose scaffold, a chitosan scaffold and a pectin scaffold.
Aspect 6. The device of any of aspects 1-5, wherein the electrolyte layer is within the decellularized biological surface, supported by a surface of the decellularized biological surface, or both within and supported by a surface of the decellularized biological scaffold.
Aspect 7. The device of any of aspects 1-6, wherein the electrolyte layer comprises a plant-based conductive hydrogel and/or a PEDOT collagen matrix.
Aspect 8. The device of any of aspects 1-7, comprising:
   a first charge collection layer disposed on the cathode layer; and
   a second charge collection layer disposed on the anode layer.
Aspect 9. The device of any of aspects 1-8, wherein the decellularized biological scaffold includes vasculature, the device comprising metal disposed in the vasculature to create electronic circuitry in the vasculature.
Aspect 10. The device of aspect 9, wherein the metal disposed in the vasculature comprises metallic vesicles.
Aspect 11. The device of aspects 9 or 10, wherein the metal disposed in the vasculature comprises a conductive polymer.
Aspect 12. The device of any of aspects 1-11, wherein the device is flexible.
Aspect 13. The device of any of aspects 1-12, wherein the device is wearable.
Aspect 14. The device of any of aspects 1-13, wherein the device is implantable.
Aspect 15. The device of any of aspects 1-14, wherein the device is biodegradable.
Aspect 16. A method of manufacturing a plant-derived battery, the method comprising:
   decellularizing a plant tissue to form a decellularized cellulose scaffold;
   contacting the decellularized cellulose scaffold with an electrolyte material to form an electrolyte layer supported by the decellularized cellulose scaffold;
   contacting the electrolyte material with an anode material to form an anode layer disposed on a first side of the electrolyte layer;
   contacting the electrolyte material with a cathode material to form a cathode layer disposed on a second side of the electrolyte layer, opposite the anode layer.
Aspect 17. The method of aspect 19 comprising:
   contacting the cathode and anode layers with a charge collection material to form a first charge collection layer disposed on the cathode layer and a second charge collection layer disposed on the anode layer.
Aspect 18. The method of aspects 16 or 17, wherein the electrolyte layer comprises a plant-based conductive hydrogel and/or a PEDOT collagen matrix.
Aspect 19. The method of any of aspects 16-18, wherein the anode and/or the cathode layer comprises metallic vesicles derived from plant-exosomes or other secreted vesicles.
Aspect 20. The method of any of aspects 16-19 comprising:
   extracting one or more metals from a plant growth medium via a hyper-accumulating plant;
   forming metallic vesicles in the hyper-accumulating plant via the extracted one or more metals;
   harvesting the metallic vesicles from the hyper-accumulating plant; and
   depositing the metallic vesicles into the plant-derived battery.
Aspect 21. The method of aspect 20 wherein the plant growth medium is a soil.
Aspect 22. The method of any of aspects 16-21, wherein the decellularizing step comprises contacting the plant tissue with supercritical CO2.
Aspect 23. A method of extracting one or more metal materials from a plant growth medium, the method comprising:
   growing a hyper-accumulating plant in the plant growth medium;
   extracting one or more metals from the growth medium into the hyper-accumulating plant;
   forming metallic vesicles in the hyper-accumulating plant;
   extracting the metallic vesicles from the hyper-accumulating plant;
   purifying the metallic vesicles.
Aspect 24. The method of aspect 23 wherein the plant growth medium is a hydroponic liquid growth medium.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Many of the molecules disclosed herein contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every formulation or combination of components described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A plant-based battery comprising:
a decellularized biological scaffold;
an electrolyte layer supported by the decellularized biological scaffold;
an anode layer disposed on a first side of the electrolyte layer; and
a cathode layer disposed on a second side of the electrolyte layer, opposite the anode layer, wherein the decellularized biological scaffold is in electrical and/or chemical communication with the first and second electrodes,
wherein the plant-based battery is configured to store and discharge electrical energy.

2. The device of claim 1, wherein the anode and/or the cathode layer comprises metallic vesicles.

3. The device of claim 1, wherein the first and/or second charge collection layers comprise metallic vesicles.

4. The device of claim 1, wherein the biological scaffold comprises a biopolymer derived from a plant.

5. The device of claim 1, wherein the biological scaffold is selected from the group consisting of a cellulose scaffold, a chitosan scaffold and a pectin scaffold.

6. The device of claim 1, wherein the electrolyte layer is within the decellularized biological surface, supported by a surface of the decellularized biological surface, or both within and supported by a surface of the decellularized biological scaffold.

7. The device of claim 1, wherein the electrolyte layer comprises a plant-based conductive hydrogel and/or a PEDOT collagen matrix.

8. The device of claim 1, comprising:
a first charge collection layer disposed on the cathode layer; and
a second charge collection layer disposed on the anode layer.

9. The device of claim 1, wherein the decellularized biological scaffold includes vasculature, the device comprising metal disposed in the vasculature to create electronic circuitry in the vasculature.

10. The device of claim 9, wherein the metal disposed in the vasculature comprises metallic vesicles.

11. The device of claim 9, wherein the metal disposed in the vasculature comprises a conductive polymer.

12. The device of claim 1, wherein the device is flexible.

13. The device of claim 1, wherein the device is wearable.

14. The device of claim 1, wherein the device is implantable.

15. The device of claim 1, wherein the device is biodegradable.

16. A method of manufacturing a plant-derived battery, the method comprising:
decellularizing a plant tissue to form a decellularized cellulose scaffold;
contacting the decellularized cellulose scaffold with an electrolyte material to form an electrolyte layer supported by the decellularized cellulose scaffold;
contacting the electrolyte material with an anode material to form an anode layer disposed on a first side of the electrolyte layer;
contacting the electrolyte material with a cathode material to form a cathode layer disposed on a second side of the electrolyte layer, opposite the anode layer.

17. The method of claim 16 comprising:
contacting the cathode and anode layers with a charge collection material to form a first charge collection layer disposed on the cathode layer and a second charge collection layer disposed on the anode layer.

18. The method of claim 16, wherein the electrolyte layer comprises a plant-based conductive hydrogel and/or a PEDOT collagen matrix.

19. The method of claim 16, wherein the anode and/or the cathode layer comprises metallic vesicles derived from plant-exosomes or other secreted vesicles.

20. The method of claim 16 comprising:
extracting one or more metals from a plant growth medium via a hyper-accumulating plant;
forming metallic vesicles in the hyper-accumulating plant via the extracted one or more metals;
harvesting the metallic vesicles from the hyper-accumulating plant; and
depositing the metallic vesicles into the plant-derived battery.

21. The method of claim 20 wherein the plant growth medium is a soil.

22. The method of claim 16, wherein the decellularizing step comprises contacting the plant tissue with supercritical CO₂.

23. A method of extracting one or more metal materials from a plant growth medium, the method comprising:
growing a hyper-accumulating plant in the plant growth medium;
extracting one or more metals from the growth medium into the hyper-accumulating plant;
forming metallic vesicles in the hyper-accumulating plant;
extracting the metallic vesicles from the hyper-accumulating plant;
purifying the metallic vesicles.

24. The method of claim 23 wherein the plant growth medium is a hydroponic liquid growth medium.
